(19) United States
(12) Patent Application Publication
(10) Pub. No.: US 2015/0278723 A1
(43) Pub. Date: Oct. 1, 2015

(54) DIMENSIONAL MULTI-LEVEL SCALE FOR DATA MANAGEMENT IN TRANSACTIONAL SYSTEMS

(71) Applicant: Microsoft Corporation, Redmond, WA (US)

(72) Inventors: Arthur Greef, Burien, WA (US); Michael Gall, Copenhagen (DK); Xavier Chape, Stenlose (DK); John Healy, Fargo, ND (US); Par Akerblom, North Bend, WA (US)

(73) Assignee: Microsoft Corporation, Redmond, WA (US)

(21) Appl. No.: 14/227,913

(22) Filed: Mar. 27, 2014

(51) Int. Cl. G06Q 10/06

(52) U.S. Cl. CPC G06Q 10/067; G06Q 10/0637

(57) ABSTRACT

Technologies are generally described for a system enabling modeling of a dimensional multi-level scale for data management. A transactional data system may be configured to track data for a variety organizations and to generate a dimensional multi-level scale for data tracked by the transactional data system based on a combination of attributes and values for each data measure tracked and recorded. The dimensional multi-level scale may define a collection of hierarchical units, where a unit may represent a tracked piece of data and may include multiple levels and sub-levels. Each unit may be characterized by attributes and attribute values at a given level in the hierarchy such that the combination of attributes and values may identify the unit. Additionally, each unit may enable additional attributes and values to be defined to further characterize a sub-level of the unit, where each sub-level may provide additional data about the unit.

### BACKGROUND

Transactional systems such as accounting systems may track data associated with various transactions and may characterize the transaction using multiple sets of attributes and dimensions that describe various characteristics at different level of details. For instance, a transaction for a quantity of received goods may be characterized by attributes such as: the item number received, an eventual item classification, a site, warehouse and rack locations where the quantity is received and stored, a number of units of the quantity received, and the date when goods get available in stock.

Some challenges with traditional transaction systems and having multiple sets of attributes and dimensions is that interrelated data may be treated as individual pieces of information, rather than interrelated data, which may result in complex data models, and may be associated with specialized code to document the transaction, and to manage integration between individual pieces of data. Additionally, the transaction data may be treated separately and may need to be validated against each other for compatibility, adding complexity and little reusable code for data validations. Transactional systems may also not capture data relevant to a current transaction. For instance, a transaction request to characterize a quantity of purchased stock may retrieve data associated with a quantity received from a supplier as well as the requested data, even though the data may not be relevant to characterize the requested purchase data.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing a system enabling modeling of a dimensional multi-level scale for data management. A transactional data system may be configured to track data for a variety of organizations and to generate a dimensional multi-level scale for data tracked by the transactional data system based on a combination of attributes and values for each data measure tracked and recorded. The dimensional multi-level scale may define a collection of hierarchical units, where a unit may represent a tracked piece of data and may include multiple levels and sub-levels. Each unit may be characterized by one or more attributes and attribute values at a given level in the hierarchy such that the combination of attributes and values may identify the unit. Additionally, each unit may enable additional attributes and values to be defined to further characterize a sub-level of the unit, where each sub-level may provide additional data about the unit.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 illustrates an example cloud based environment where a transactional data system may be implemented;

FIG. 2 illustrates an example transactional application server where a multi-level dimensional scale for data management may be implemented;

FIG. 3 illustrates an example schematic of modeling a dimensional multi-level scale for a data management system;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of modeling a dimensional multi-level scale for data management, according to embodiments.

### DETAILED DESCRIPTION

As briefly described above, a dimensional multi-level scale for data management at a transactional data system is provided. The transactional data system may track data for a variety organizations and may generate a dimensional multi-level scale for the tracked data based on a combination of attributes and values for each data measure tracked and recorded. The dimensional multi-level scale may define a collection of hierarchical units, where a unit may represent a tracked piece of data and may include multiple levels and sub-levels. Each unit may be characterized by one or more attributes and attribute values at a given level in the hierarchy such that the combination of attributes and values may identify the unit. Additionally, each unit may enable additional attributes and values to be defined to further characterize a sub-level of the unit, where each sub-level may provide additional data about the unit. Defining each level and sub-level within a hierarchy may enable multiple levels of data to be associated together to enable efficient data tracking and analysis, and may also enable scaling of data. A measure as used herein may be for example length or similar entity. A measurement, on the other hand, refers to an occurrence of a measure on a scale (e.g., length of 5 on a meter scale).

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for a multi-level dimensional scale for data management. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

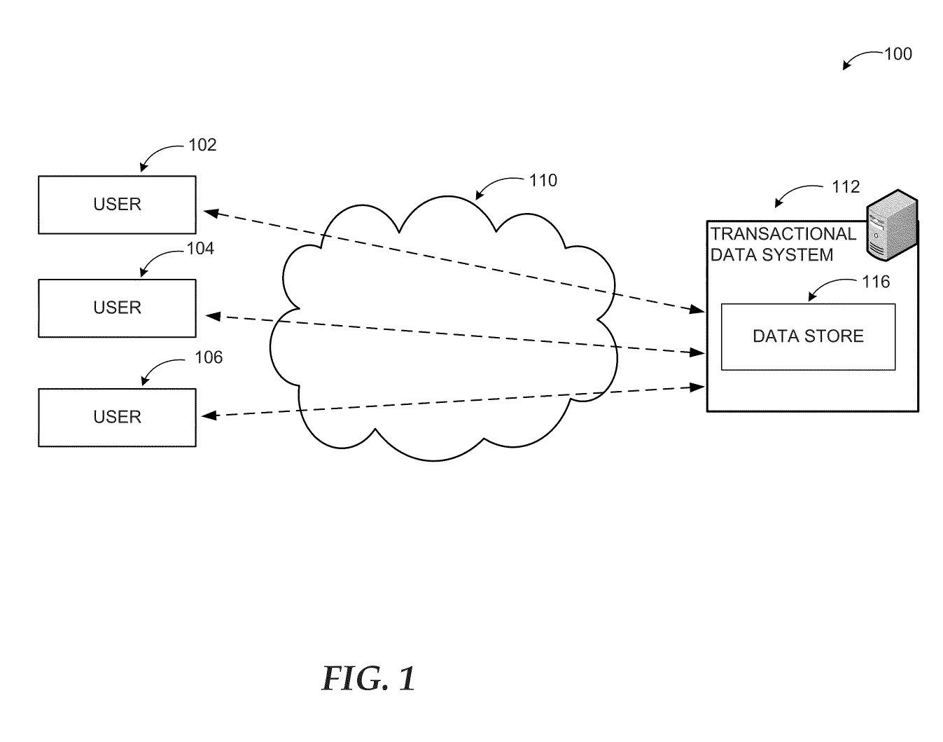

FIG. 1 illustrates an example cloud based environment where a transactional data system may be implemented, according to some embodiments herein.

As illustrated in a diagram 100, a transactional data system may be accessed by multiple users (e.g. users 102, 104, 106) over a network such as a cloud based network 110. An example transactional data system 112 may provide tracking, recording, and retention or storage of data associated with an entity, organization, or system, such as a business enterprise. The transactional data system 112 may be operated locally on one or more computing devices of the organization. In another embodiment, the transactional data system 112 may be provided as a cloud-hosted application to an organization, and may be provided over the cloud based network 110 to one or more computing devices where it may be locally accessed and interacted with as a locally installed application.

Some example transactions that may be tracked and retained by the transactional data system 112 may include financial transactions such as orders, invoices, and payments, work product and activity records, transaction logistics such as deliveries, inventory, storage records, travel records, and accounting transactions. Recorded transactions may be stored in a data store 116 associated with the transactional data system 112. The data store 116 may enable retention of raw data associated with transactions, and may also store source documents associated with various tracked transactions to enable data accessibility and analysis. The data store may store the data, for example, in tables, databases, lists, text files, or any other data format suitable for the transactional data system 112.

The data tracked and recorded by the transactional data system 112 may be characterized using multiple sets of attributes and dimensions that describe various facets and characteristics of the tracked data at different levels of detail for a transaction. For instance, the transaction for a quantity of received may be characterized by attributes such as item identity, a quantity received, an eventual item classification, a site, warehouse and rack locations where the quantity is received and stored, and the date when goods become available in stock. Some challenges with traditional transaction systems and having multiple sets of attributes and dimensions is that interrelated data may be treated as individual pieces of information which may results in complex data models, and may be associated with specialized code to document the transaction, to analyze the transaction, and to control coherence and interrelation between individual pieces of data. A system according to embodiments may provide a multi-level dimensional scale for data management at the transactional data system 112.

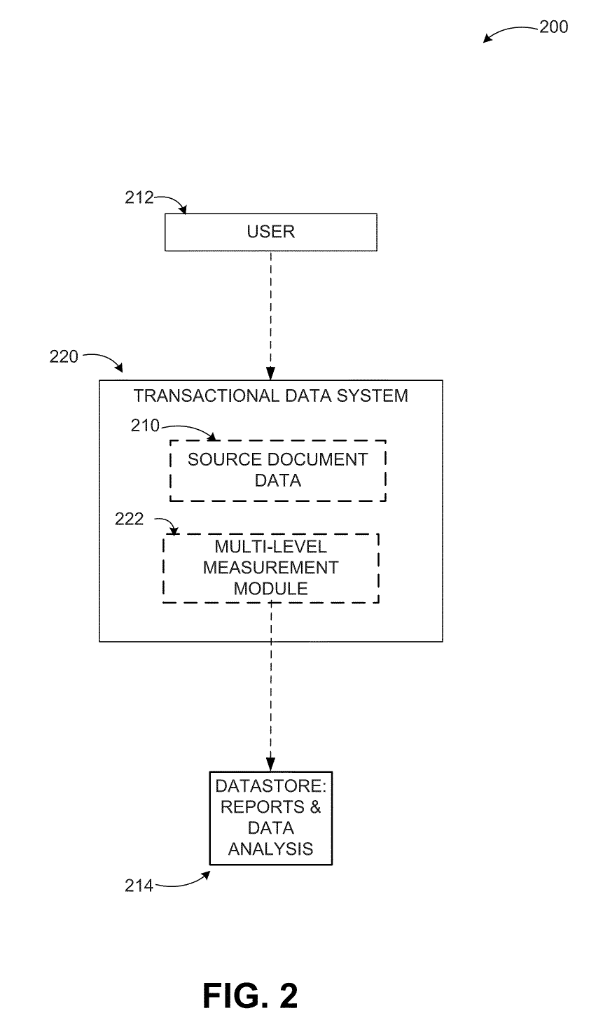

FIG. 2 illustrates an example transactional application server where a multi-level dimensional scale for data management may be implemented, according to some embodiments herein.

As illustrated in a diagram 200, a dimensional multi-level measurement module 222 may provide a dimensional multi-level scale for data management at a transactional data system 220. The dimensional multi-level measurement module 222 may model a multi-level hierarchy for data tracked by the transactional data system 220 based on a combination of attributes and values for each data measure tracked and recorded. The transactional data system 220 may be configured to track data for a variety of systems and organizations, and to generate comprehensive data reports 214 for data analysis based on the tracked data.

In an example embodiment, source documents 210 may be documents generated by or read by the transactional data system 220 in order to gather and receive data associated with various transactions tracked and recorded by the transactional data system 220. Examples of source documents 210 may include, without limitation, a purchase order, an invoice, a receipt, a shipping order, a receiving report, an inventory list, and so forth. Source documents 210 may be provided from within the transactional data system 220, for example, through a document entry user interface that provides fields that a user 212 may fill in with data relevant to the event or document. Additionally, source documents 210 may be provided externally to the transactional data system 220, for example, via a web-browser enabled form that accepts the document data entered by a user and provides the document data to the transactional data system 220 directly, or makes the data available for the transactional data system 220 to access. The source documents 210 and data from the source documents 210 may be recorded at the data store to enable data tracking and analysis of transactions associated with the transactional data system 220. The above described examples are not intended to be limited to these examples, but are exemplary of data that may be gathered and tracked by a transactional data system to build a multi-level model.

In an example embodiment, the dimensional multi-level scale may define a collection of hierarchical units, where a unit may represent a tracked piece of data and may include multiple levels and sub-levels. Each unit may be characterized by one or more attributes and attribute values at a given level in the hierarchy. The combination of attributes and values may identify the unit. Additionally, each unit may enable additional attributes and values to be defined to further characterize a sub-level of the unit, where each sub-level may provide additional data about the unit. Each sub-level unit may inherit attributes and values of its parent unit and may add additional attributes and values. The addition of additional attributes and values may be automatic based on detected tracked data, or additional attributes and values may also be manually defined by a user 212 to add information desired by the user 212. Manual definition of sub-level attributes and values may enable the user 212 to incrementally define a scale at multiple levels of precision, leaving the user the ability to specify concrete defining attributes and/or values of sub-level units at the user's discretion. A data entry pane may be provided to the user 212 at the user's client device along with a source document or with a data received data report to enable manual entry of custom attributes and values. Once manually entered, the custom attributes and values may become integrated as a part of the model for the tracked data.

The defined units at each level and sub-level may be stored within a data store associated with the transactional data system to enable comprehensive data management and analysis. Defining each level and sub-level within a hierarchy may enable multiple levels of data to be associated together to enable efficient data tracking and analysis, and may also enable scaling of data. Furthermore, the hierarchy may be applicable to various data types and measurements to generate a model applicable to data being tracked. For example, if location data is being tracked, a location model of the multi-level scale may be employed, while a cost basis model of the multi-level scale may be employed for tracking cost data associated with a transaction. Other multi-level dimensional models may also be generated such as accounting models, organization models, and the like based on a type of tracked data. A conversion factor may be provided, which may enable the conversion of a magnitude of measurement expressed on a set of units into another magnitude of measurements on another set of units using a different scale. That is, the dimensional multi-level scale may enable identification and projection of values from one domain or model to another, by enabling conversion of a measurement expressed on a set of units in a first model into other measurements on another set of units in a second model.

In an example scenario for modeling a location model dimension multi-level scale for received goods based on location, location dimensions units may be defined along with characterizing attributes including site location, warehouse location, and rack location. A location unit dimension may be first defined, where the location unit may be for example, Loc#1. The location unit may be characterized by an attribute for a site, and its value, Site #1. A sub-level, or child unit, of the location unit, Loc#1, may also be defined, such that attributes that characterize a sub-location of the site may be defined to provide an additional level of detail. An attribute characterizing the sub-location of the site may be an attribute for a warehouse. For instance, a location unit dimension, Loc#2, for a particular warehouse in Site#1 may be defined as a sub-location of the Site #1 dimension, and may be characterized by the site attribute and its value, Site #1, and the warehouse attribute and its value, Wrh#1.

In an example embodiment, each unit dimension for characterizing data measurements in the transactional data system may be assigned in conformity with a measure prescribed level of dimension. For example, if the data measurement is a purchased quantity of goods, the measure for the purchased quantity involves a location unit scaled at a site level to characterize a magnitude of goods acquired at the site. Similarly, if the data measurement is a registered quantity of goods in stock, the measure for the registered quantity involves a location dimension unit scaled at the warehouse level to characterize a magnitude of goods available in stock in a particular warehouse. The measurement for the purchased quantity may thus feature a location unit dimension, which may be Loc#1, which includes a site attribute, which may be Site#1, while the measurement for the registered quantity may also feature a location unit of dimension, which may be Loc#2, which may be a sub-level of Loc#1, and may include a site attribute, which may be Site#1, and a warehouse attribute, which may be Wrh#1, characterizing a quantity acquired and delivered at warehouse #1 at Site #1.

Table 1 below demonstrates example application of a dimensional multi-level scale for tracking location data.

TABLE 1

| | | Parent | | | | |
|---|---|---|---|---|---|---|
| Model | Unit | Unit | Name | Defining Attributes | | |
| Location Model | | | | Site | Warehouse | Area |
| Location | Loc#1 | | NY | NY | | |
| Location | Loc#2 | Loc#1 | Broadway | NY | Broadway | |
| | | | NY | | | |
| Location | Loc#3 | Loc#2 | Broadway | NY | Broadway | Area 1 |
| | | | NY A1 | | | |

As discussed previously, Loc#1 is defined by a site attribute where the site attribute includes a value for the site, which may be NY, in the above table. Similarly, Loc#2 is defined by a site attribute and a warehouse attribute where NY is a value for the site and Broadway is a value for the warehouse. The Loc#2 unit is a sub-level of the Loc#1 unit, and automatically inherits the site attribute. The Loc#2 unit is also characterized by a warehouse attribute, where Broadway is a value for the warehouse attribute. In a further example, Loc#3 unit is a sub-level of the Loc#2 and Loc#1 units and is characterized by the combination of site, warehouse, and area attributes, and their corresponding values, site=NY, warehouse=Broadway, and area=Area 1.

In a system according to embodiments, defining a dimensional multi-level scale may be applicable to characterizing other models and derived measurements in other transactions and systems, such as accounting systems, including resource accounting, sub-ledge accounting, and general ledge accounting measurements. The dimensional multi-level scale may define a collection of hierarchical units for a defined measurement of the tracked system, where each defined unit may represent a tracked piece of data and includes multiple levels and sub-levels. As described above, each unit may be characterized by a combination of attributes and attribute values at a given level in the hierarchy, where each sub-level provides additional levels of detail related to the tracked data.

Table 2 below demonstrates a cost control model of a dimensional multi-level scale for tracking cost data.

TABLE 2

| | | Parent | | | | | |
|---|---|---|---|---|---|---|---|
| Model | Unit | Unit | Name | Defining Attributes | | | |
| Cost Control Model | | | | Organization | Activity | Resource | Location |
| Cost | CO#0 | | CEU-Cost | ORG#1 | | | |
| Object | | | CTL | | | | |
| Cost | CO#1 | CO#0 | CEU-Inv | ORG#1 | ACT#2 | | |
| Object | | | | | | | |
| Cost | CO#2 | CO#1 | CEU-INV- | ORG#1 | ACT#2 | RES#3 | LOC#2 |
| Object | | | Broadway | | | | |
| | | | NY, | | | | |
| | | | product X | | | | |
| Cost | CO#3 | CO#2 | CEU-INV- | ORG#1 | ACT#2 | RES#3 | LOC#5 |
| Object | | | Broadway | | | | |
| | | | NY, | | | | |
| | | | product X | | | | |

A Cost Control Model may be defined via the dimensional multi-level scale to measure a cost assigned to cost objects. Cost object dimension units may be defined as a combination of other dimension units relevant to cost data. For instance, cost object CO#3, for measuring a cost of inventory activities (Activity Unit=ACT#2) conducted by entity CEU (Organization unit=ORG#1) for stock of product X (product unit=RES#3) at the Broadway warehouse at the New York Site (Location unit=LOC#2) may be defined as follows: Cost object unit CO#3 may be a sub-unit of the cost object unit CO#2 representative of inventory activities conducted by the entity CEU. Therefore CO#3 may be defined as a combination of attributes and values inherited from its parent unit CO#2, which may be Activity Unit ACT#2 and Organization Unit ORG#1, and attributes characterizing sub-unit CO#3, which may be Resource Unit RES#3 and Location Unit Loc#5 as seen above in Table 2.

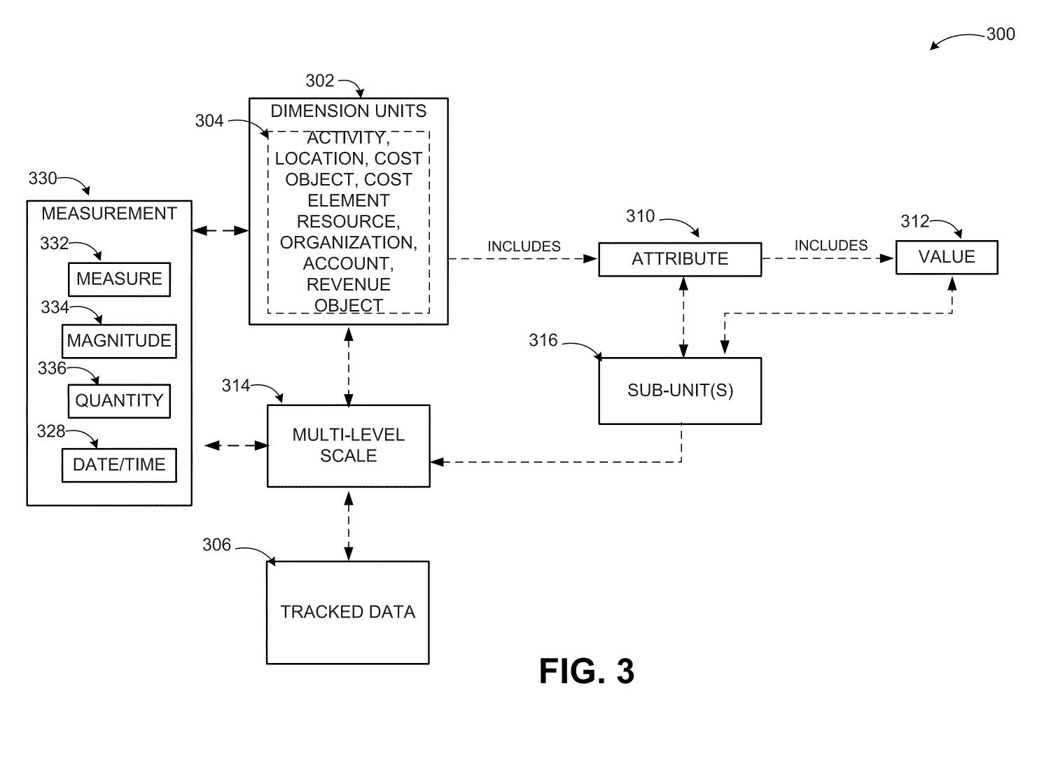

FIG. 3 illustrates an example schematic of modeling a dimensional multi-level scale for a data management system, according to some embodiments herein.

In the example schema illustrated in a diagram 300, a dimensional multi-level scale 314 defines a multi-level hierarchy for data 306 tracked by a transactional system. In an example embodiment, the dimensional multi-level scale 314 may define a collection of hierarchical units 302 for measured data, where each unit 302 represents a tracked piece of data and can include multiple levels and sub-levels. Each unit 302 is defined by a set of attributes 310 and attribute values 312 whose combination identifies the unit 302. The units 302 may be defined based on an identified measurement 330 of the data 306 being tracked and modeled. Based on the identified measurement of the data being tracked, a measurement specific model may be generated, and the units 302 may be defined based on the generated model. Some example models may include a location model, a revenue model, a cost object model, and example model specific units 304 may include activity, location, resource, organization, cost object, cost element, account, and revenue object. The example models and units are not intended to be limiting, but are exemplary of data that can be tracked and modeled employing a dimensional multi-level scale as described herein. The units 302 may be automatically defined based on the tracked model and detected data. The units 302 may also be user-defined to enable the dimensional multi-level scale to be customizable and scalable such that it can be applied to any data management system to track and model data.

In an example embodiment, each unit may also enable additional attributes and values to be defined to further characterize a sub-level 316 of the unit, where each sub-level 316 may provide additional data about the unit. A sub-level 316 of a unit may inherit its parent unit's defining attributes and attribute values, to which additional defining attributes and values may be added as defined by the parent unit. The additional defined attributes may be assigned to identify each sub-level unit. The additional defined attributes may be defined manually by a user in order to track user-defined data, or may be generated automatically by the model in response to detected data.

In a system according to embodiments, the measurement 330 may define a category of data being tracked and modeled by the dimensional multi-level scale 314. Additional information may also be integrated with the dimensional multi-level scale 314, and may include, measures 332, which may identify a collection of dimensions needed to characterize instances of the measurements, a quantity 336, which may be numeric, a magnitude 334, which may be a unit of a quantity (e.g., dollars and units), and a date/time 328 unit of measure, which may include date and time information associated with tracked data.

The example applications, devices, and modules, depicted in FIGS. 1-3 are provided for illustration purposes only. Embodiments are not limited to the configurations and content shown in the example diagrams, and may be implemented using other engines, client applications, service providers, and modules employing the principles described herein

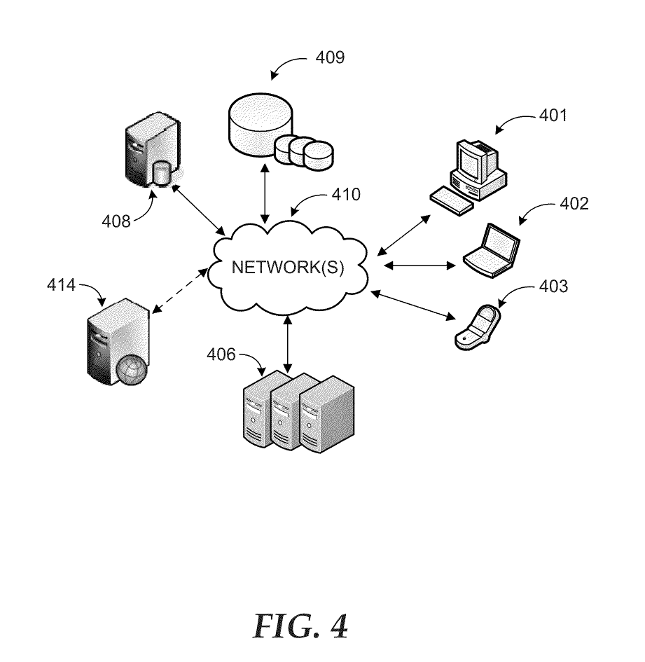

FIG. 4 is an example networked environment, where embodiments may be implemented. In addition to locally installed applications, a transactional system application enabling modeling of a dimensional multi-level scale for data management may also be employed in conjunction with hosted applications and services that may be implemented via software executed over one or more servers 406 or individual server 414. A hosted service or application may communicate with client applications on individual computing devices such as a handheld computer, a desktop computer 401, a laptop computer 402, a smart phone 403, a tablet computer (or slate), (client devices′) through network(s) 410 and control a user interface presented to users.

Client devices 401-403 may be used to access the functionality provided by the hosted service or application. One or more of the servers 406 or individual server 414 may be used to provide a variety of services as discussed above. Relevant data may be stored in one or more data stores (e.g., data store 409), which may be managed by any one of the servers 406 or by database server 408.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared, and other wireless media.

Many other configurations of computing devices, applications, data sources, and data distribution systems may be employed to implement a system enabling modeling of a dimensional multi-level scale for data management. Furthermore, the networked environments discussed in FIG. 4 are for illustration purposes only. Embodiments are not limited to the example applications, modules, or processes.

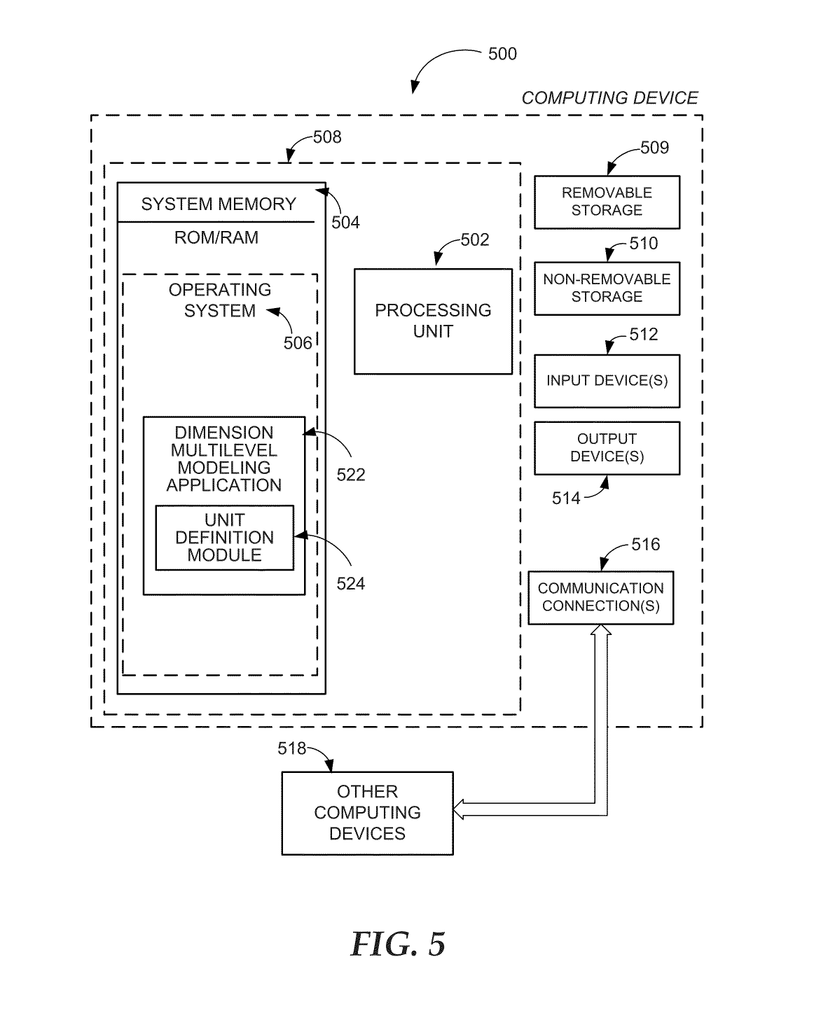

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, a computing device 500 may be any of the example devices discussed herein, and may include at least one processing unit 502 and a system memory 504. The computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 506 suitable for controlling the operation of the platform, such as the WINDOWS®, WINDOWS MOBILE®, or WINDOWS PHONE® operating systems from MICROSOFT CORPORATION of Redmond, Wash. The system memory 504 may also include one or more software applications such as program modules 506, a dimension multi-level modeling application 522 and a unit definition module 524.

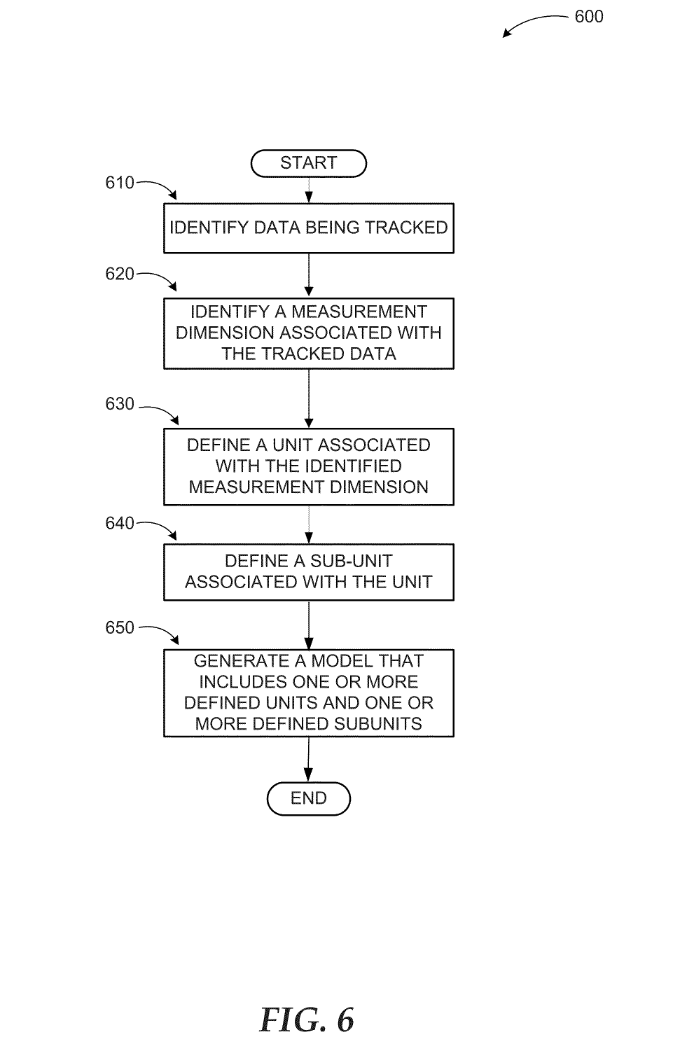

The unit definition module 524 may operate in conjunction with the operating system 506 and the dimension multi-level modeling application 522 to identify transaction data being tracked at a transactional data system, and to define units and sub-units applicable to the data being tracked to generate a dimensional multi-level scale for data management. This basic configuration is illustrated in FIG. 6 by those components within dashed line 508.

The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, an optical capture device for detecting gestures, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, other directory or policy servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

FIG. 6 illustrates a logic flow diagram for a process of modeling a dimensional multi-level scale for data management. Process 600 may be implemented as part of an application or an operating system.

Process 600 begins with operation 610, “IDENTIFY DATA BEING TRACKED,” where data being tracked as part of a transactional data system may be identified. The data may be identified from a source document, which may be a report including data fields associated with a tracked transaction at a transactional data system.

Operation 610 is followed by operation 620, “IDENTIFY A MEASUREMENT DIMENSION ASSOCIATED WITH THE TRACKED DATA,” where a measurement dimension associated with the tracked data may be identified. The measurement dimension may define a category of data being tracked and modeled by the dimensional multi-level scale.

Operation 620 is followed by operation 630, “DEFINE UNIT ASSOCIATED WITH THE IDENTIFIED MEASUREMENT DIMENSION,” where units for modeling the dimensional multi-level scale may be defined. The units may be defined based on the identified measurement of the data being tracked and modeled. Each unit may be characterized by one or more attributes and attribute values at a given level in the dimensional multi-level scale such that the combination of attributes and values may identify the unit. Example measurement specific units may include activity, location, resource, organization, cost object, cost element, account, and revenue object, as some non-limiting examples.

Operation 630 is followed by operation 640, “DEFINE A SUB-UNIT ASSOCIATED WITH THE UNIT,” where a sub-unit may be defined to provide additional data about the unit. A sub-unit may inherit its parent unit's defining attributes and attribute values, to which additional defining attributes and values may be added as defined by the parent unit. The additional defined attributes may be assigned to identify each sub-unit.

Operation 640 may be followed by operation 650, “GENERATE A MODEL THAT INCLUDES ONE OR MORE DEFINED UNITS AND ONE OR MORE DEFINED SUB-UNITS,” where a data model may be provided to enable data analysis of a transaction. The model may include the defined units and sub-level units, and a report may be generated based on the model to enable data analysis based on the one or more units and the one or more sub-units.

In some embodiments, a model that defines a multi-dimensional scale may be used to define at least one attribute and a related value based on one or more dimensions and units of other scales or models. For example, the cost control model may define a cost object unit using as defining attribute of the resource dimension of a resource scale and that scale's units (RES#1 . . . RES#n) as related defining attribute values. In other embodiments, operations and conversion of measurements that are expressed on an individual nominal scale may be handled consistently for product quantity measure on a resource dimension. For example, a measurement may be expressed on a multidimensional dimensional scale, for product cost measure on cost object dimension. This is similar to surface measurements on a square meter scale, which is outcome of multiplying the distance measure measurements of length and width dimensions, on a meter scale.

The operations included in process 600 are for illustration purposes. Modeling a dimensional multi-level scale for data management according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device to model a dimensional multi-level scale for data management, the method comprising:
identifying data being tracked;
identifying a measurement dimension associated with the tracked data;
defining a unit associated with the identified measurement dimension;
defining a sub-unit associated with the unit; and
generating a model that includes one or more defined units and one or more defined sub-units.

2. The method of claim 1, further comprising:
generating a report based on the model, wherein the report enables data analysis based on the one or more units and the one or more sub-units.

3. The method of claim 1, wherein identifying data being tracked further comprises:
tracking transactional data as part of a transactional data system.

4. The method of claim 3, wherein the transactional data includes one or more of: orders, invoices, and payments, work product and activity records, transaction logistics, deliveries, inventory, storage records, travel records, and accounting transactions.

5. The method of claim 1, wherein identifying data being tracked further comprises:
tracking and receiving data associated with a transaction from one or more source documents.

6. The method of claim 5, wherein the one or more source documents include at least one of: a purchase order, an invoice, a receipt, a shipping order, a receiving report, and an inventory list.

7. The method of claim 1, further comprising:
characterizing the defined unit by one or more attributes and one or more attribute values.

8. The method of claim 7, further comprising:
enabling one or more additional attributes and attribute values to be defined to further characterize the sub-unit associated with the defined unit, wherein the defined sub-unit provides additional data about the defined unit.

9. The method of claim 8, wherein the defined sub-unit is arranged to inherit the one or more one or more attributes and the one or more attribute values of its associated parent unit, and includes the one or more additional attributes and attribute values further characterizing the defined sub-unit.

10. The method of claim 7, further comprising:
automatically defining the one or more additional attributes and attribute values of the defined sub-unit based on the identified tracked data; and
enabling manual definition of the one or more additional attributes and attribute values of the defined sub-unit.

11. The method of claim 7, wherein
a model that defines a multi-dimensional scale is used to define at least one attribute and a related value based on one or more dimensions and units of other scales or models; and
operations and conversion of measurements that are expressed on an individual nominal scale are handled consistently for product quantity measure on a resource dimension.

12. A computing device to model a dimensional multi-level scale for data management, the computing device comprising:
a memory;
a processor coupled to the memory, the processor executing a dimensional multi-level measurement module at a transactional data system configured to model the dimensional multi-level scale, wherein the processor is configured to:
identify data being tracked at the transactional data system;
identify a measurement dimension associated with the tracked data;
define a unit associated with the identified measurement dimension, wherein the unit is characterized by one or more attributes and one or more attribute values;
define a sub-unit associated with the unit, wherein the sub-unit inherits the one or more attributes and the one or more attribute values from its associated unit; and
generate a model that includes one or more defined units and one or more defined sub-units.

13. The computing device of claim 12, wherein the processor is further configured to:
identify and receive the data being tracked at the transactional data system from a source document associated with the tracked data, wherein the one or more source documents are provided through one of: a document entry user interface that provides data entry fields or via a web-browser enabled form that accepts data entry and enables indirect and direct access to the source document by the transactional data system.

14. The computing device of claim 12, wherein the defined units and sub-units include one or more of: an activity, a location, a resource, an organization, a cost object, a cost element, an account, and a revenue object.

15. The computing device of claim 12, wherein the generated model includes one or more of: a location model, a revenue model, and a cost object model.

16. The computing device of claim 12, wherein the processor is further configured to:
provide a conversion factor to enable the conversion of a measurement expressed on a set of units in a first model into another measurements on another set of units in a second model.

17. The computing device of claim 12, wherein the processor is further configured to:
provide a data entry pane with a source document to enable manual entry of custom attributes and attribute values.

18. A computer-readable memory device with instructions stored thereon model a dimensional multi-level scale for data management at a transactional data system, the instructions including:
identifying data being tracked at the transactional data system;
identifying a measurement dimension associated with the tracked data;
defining a unit associated with the identified measurement dimension, wherein the unit is characterized by one or more attributes and one or more attribute values;
defining a sub-unit associated with the unit; and
generating a measurement specific model that includes one or more defined units and one or more defined sub-units, wherein the one or more units and the one or more sub-units are defined based on the generated measurement specific model.

19. The computer-readable memory device of claim 18, wherein the unit represents the tracked data as a collection of hierarchical units and each unit includes multiple levels and sub-levels.

20. The computer-readable memory device of claim 18, wherein instructions further comprise:
integrating with the measurement specific model one or more of: a quantity, a magnitude, and a date and/or time unit of measure associated with tracked data.
